(19) United States
(12) Patent Application Publication
(10) Pub. No.: US 2007/0120342 A1
(43) Pub. Date: May 31, 2007

(54) Detachable bicycle frame connectors

(76) Inventor: Kenneth Marvin Daniels, southfield, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/164,613

(22) Filed: Nov. 30, 2005

(51) Int. Cl. B62K 15/00

(52) U.S. Cl. 280/287

(57) ABSTRACT

Conventionally, bicycles are classified as ones featuring a fixed frame, a foldable frame and a detachable frame. The fixed frames although adequate in structure strength and having less restriction on design they occupy space during transportation and/or storage. Today many cars have a rack for fastening a bicycle on so that a driver can carry it while going on a trip. However, the fastening process is tedious and cumbersome and adversely affects safety during driving. Moving to the second classification, the folding frame, they are adequate in saving space in transportation and/or storage, they are also suitable for being transported inside a car, while in the mean time being structurally weak because of a potential breakage occurring at the folded portions of the bicycle. At this, reinforcements are then added at the folded portions, detracting the bicycles appearance, as a result, only a few types of the folding bicycles are popular in the market place today. Now moving to the third classification, the detachable bicycle, while having a structure with fewer restrictions on design, you have the flexibility of detaching the bicycle for transportation and/or storage. Unfortunately, the current detachable frames have four problems, a. Frame aliment. b. Stability c. Rigid ness of frame d. You need wrenches to detach the frame. That means wrenches that have to be carried around that could be forgotten or lost. In addition, bolts that can rust and become difficult to remove or even become striped and need replacing. Not only is this time consuming, it could render the detachable portion of the bicycle useless.

### BRIEF DESCRIPTION OF VIEWS IN DRAWINGS

FIG. A. Is a photo of the top and bottom outer sleeve-E of the connector with safety pin in place. The outer sleeve holds the frame together, and the safety pin will lock the sleeve into place, because the pin has balls in the end and they will not retract until the blue button is pressed in, this releases the balls so the pin can be removed.

FIG. 1. Is a sketch of the bottom connector installed on bottom bar of the front and rear frame. The connector holds the bottom bar of the frame together.

FIG. 2. Sketch of location for color-coded brake and gear quick disconnects. These quick disconnects allows you to disconnect the cables, so that the front section of frame can completely disconnected from the rear.

FIG. 3. Engineered drawing of the main body for the bottom frame connector. The main body inserts into the frame (end-C) and then is drilled and pinned in place. The other end Protrudes from the frame so the outer sleeve has something to hold onto, and the groove is for a safety thumbscrew or automatic spring-loaded plunger.

FIG. 4. No longer needed.

FIG. 5. Solid model cross section drawing of the bottom frame connector assembly.

FIG. 6. Solid drawing of bottom frame connector for thread location.

FIG. 6E. Engineered drawing of outer sleeve for the bottom frame connector. This holds main body and secondary bodies together; the hole is for a safety screw or spring loaded plunger that will lock into the main body.

FIG. 6D. Engineered drawing of the secondary body for the bottom frame connector, which fits into the frame with the other end protruding with threads, so the outer sleeve can lock together.

FIG. 7. Sketch of location for frame connectors.

FIG. 8. Solid model drawing, identifying different section of top frame connector. This connector holds top bar of frame together.

FIG. 8E. Engineered drawing of outer sleeve for the top frame connector. This holds main body and secondary body together; the hole is for a safety screw that will lock into the main body.

FIG. 8D. Engineered drawing of secondary body for the top frame connector, which fits into the top bar with the other end protruding with threads, so the outer sleeve can lock together. The drilled through hole is for the main body (end-B) to insert and alien frame.

FIG. 9. Engineered drawing of main body for top frame connector. (end-C) inserts into top bar of frame while the other end (end-B) protrudes out of frame, so it can alien with the secondary body of the connector that is inserted into the other end of frame, giving a solid rigid support. The one-inch hole is for weight control.

FIG. 10. Solid model drawing of top frame connector with details of connector.

FIG. 11. Sketch of condensed bicycle with definitions.

FIG. 11A. Photo of right side of condensed bicycle with definitions.

FIG. 11B. Photo of left side of condensed bicycle with definitions.

FIG. 12. Sketch of pathway for color-coded brake and gear cables.

FIG. 13. Sketch of bicycle divided into its front and rear sections with definitions.

FIG. 14 solid model assembly drawing of front wheel connector. This is located on left side of rear wheel and the front wheel attaches to it in its compact position.

FIG. 14A. Engineered drawing of the top of the front wheel connector. The groove is for the insertion of the front wheel, the holes are for location for the bottom section of the front wheel connector. The thickness of the part is calculated, so that it is at the same size, so you have minimal adjustments to make when locking front wheel into place.

FIG. 14B. Engineered drawing of the bottom of the front wheel connector. The groove is for the insertion of the rear axle and nut, it can be turned so to load front wheel from the front, top, or back. The threaded holes are for the location of the top section of the wheel connector. The height of the wheel connector gives clearance between the wheels so that when it is in its compact position the left flip peddles clears the front wheel as you roll it around.

FIG. 15. Sketch of fully assembled bicycle with location of top and bottom connectors along with definitions.

FIG. 15A. Photo of fully assembled bicycle with location of the top and bottom connectors along with definitions.

FIG. 16. Sketch of the front and rear yoke connector assembly. The springs purpose is to hold the adjusting lock finger in the unlock position. The setscrew keeps the adjusting finger from bottoming out against the spring or letting the finger fall out of body. The thumbscrew allows you to lock the front of frame to the rear of frame along with the locking pin. The locking pin is located on the right side of rear wheel.

FIG. 17A. Photo of bicycle in its compact state without definitions. (Left side)

FIG. 17B. Photo of bicycle in its compact state without definitions. (Right side)

FIG. 18A. Photo of bicycle in its compact state without definitions. (Front view)

FIG. 18B. Photo of bicycle in its compact state without definitions. (Rear view)

FIG. 18C. Photo of bicycle in its full size position with front and rear yoke connector location.

FIG. 18D. Photo of secondary bolt location. This bolt secures front section and rear section of frame in its compact state.

FIG. 19A. Photo of front and rear frames being assembled, along with location of front and rear yoke connector.

FIG. 19B. Solid model cross-section of x and y planes of top frame connector assembly with definitions.

FIG. 20A. Photo of front wheel being removed.

FIG. 20B. Photo removing front brake quick release.

FIG. 21A. Photo for location of front wheel connector.

FIG. 21B. Photo for location of front wheel connector and location of quick release axle lock.

FIG. 22A. Photo of alignment of red dot before tightening top connector, so that the safety plunger holes will alien.

FIG. 22B. Photo of alignment of red dot before tightening top connector, so that the safety plunger holes will alien.

FIGS. 23A and 23B. Photo for repositioning of seat for minimizing the height of bicycle while in its compact state.

FIG. 24B. Photo of two 26-inch mountain bikes in the trunk of a car. To show how compact, the bicycles become.

FIG. 24C. Photo of bicycle in its compact state being rolled around.

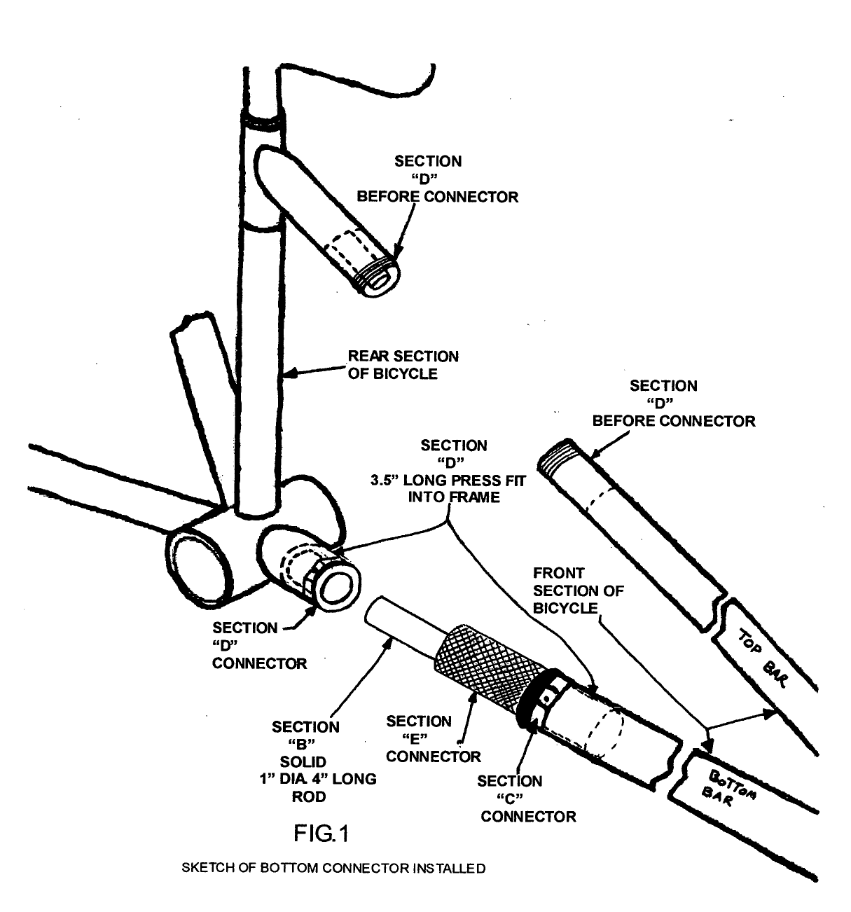

What is claimed is:

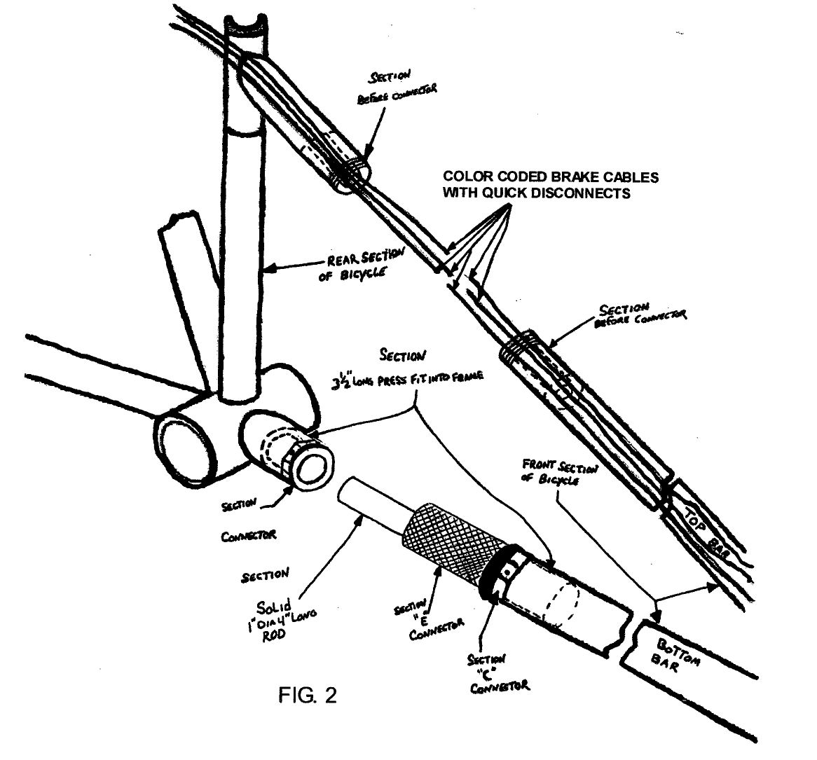

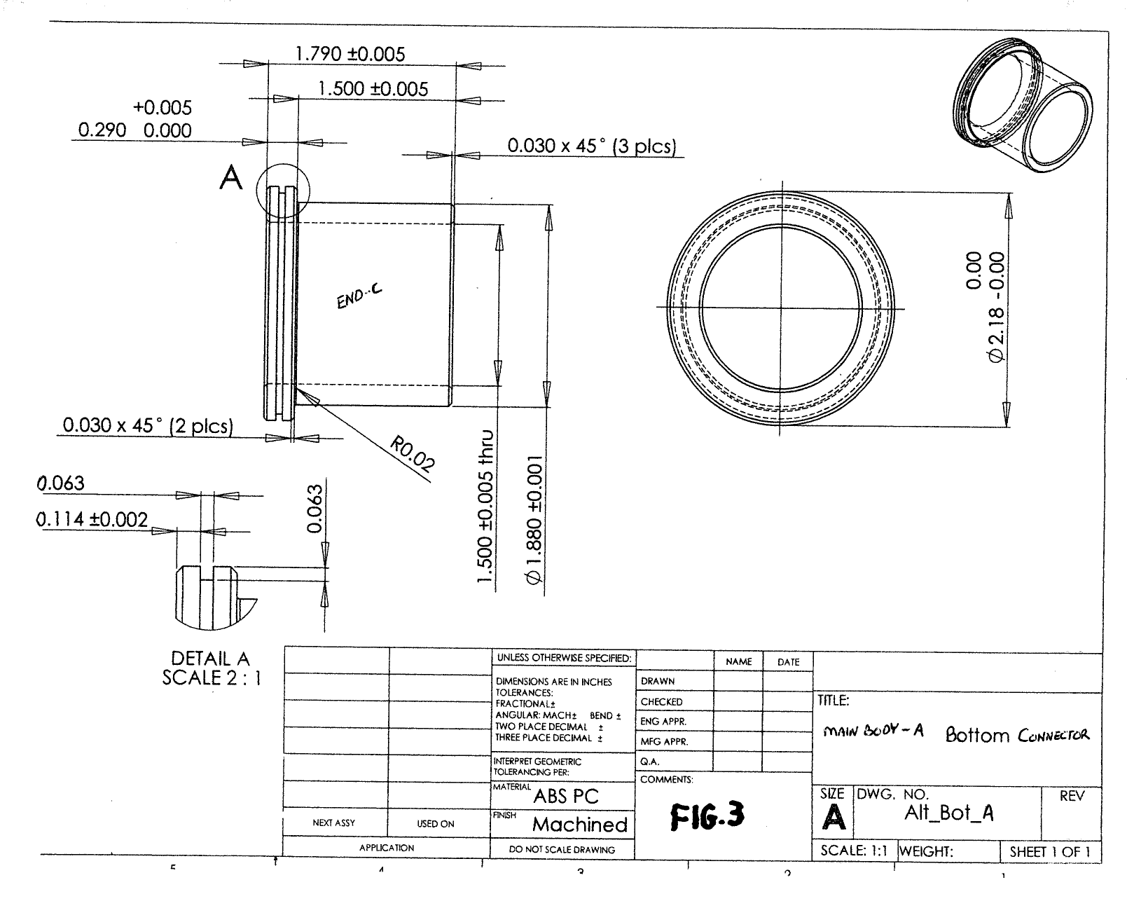

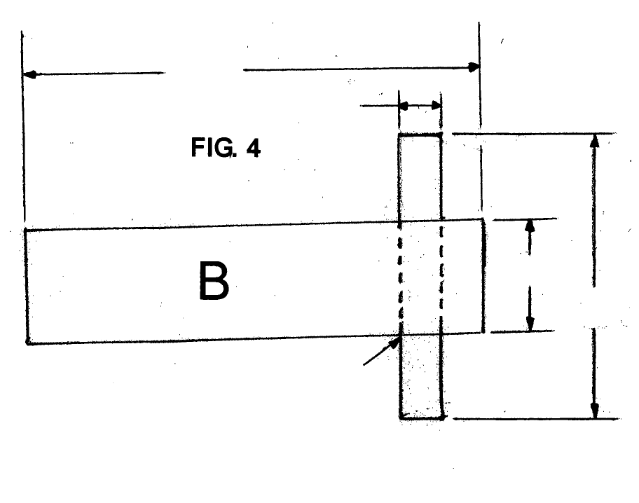

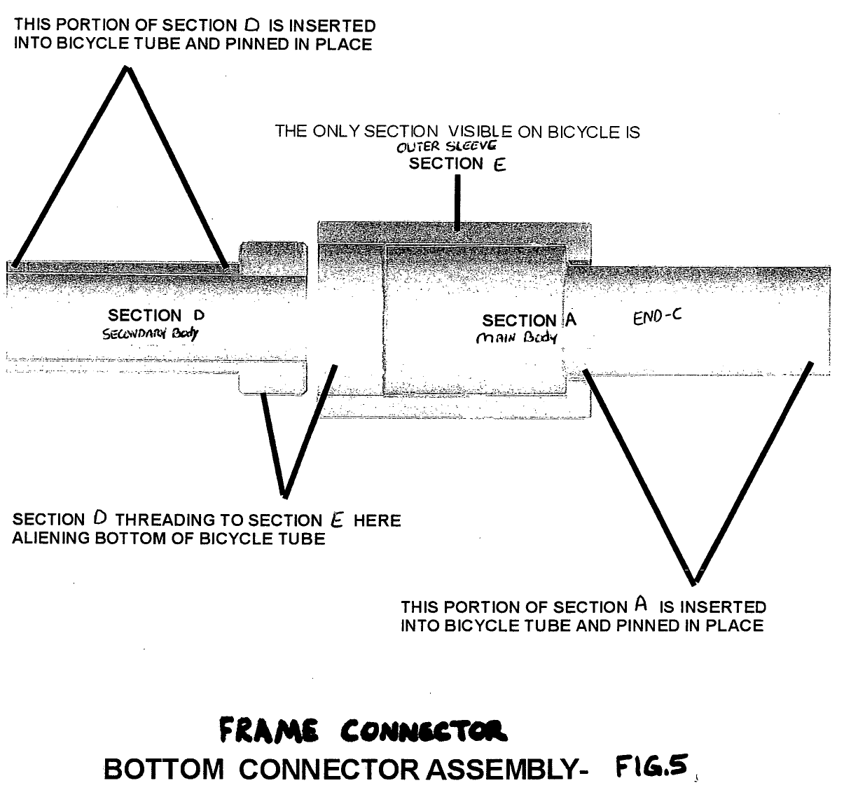

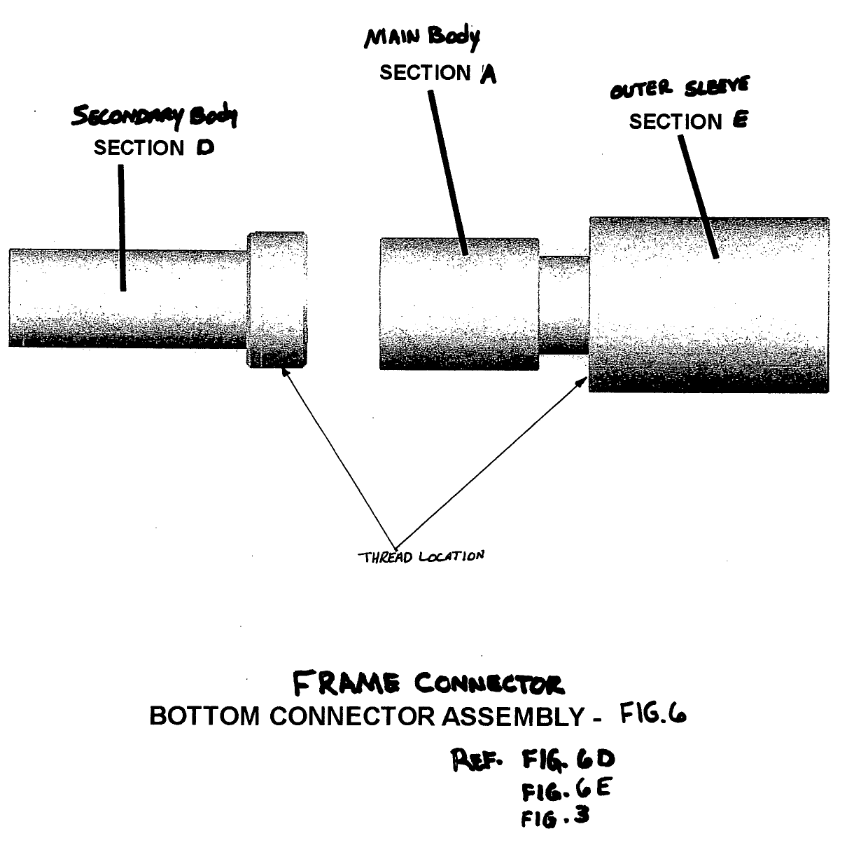

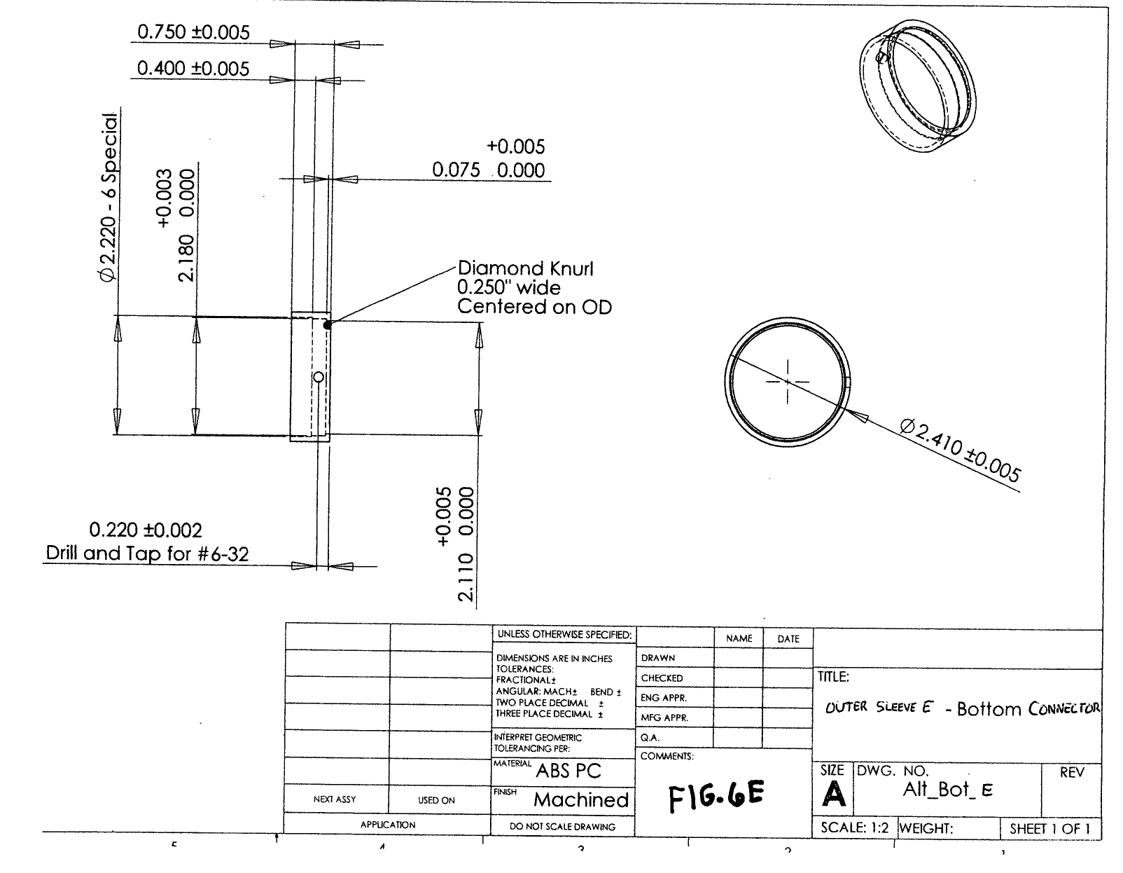

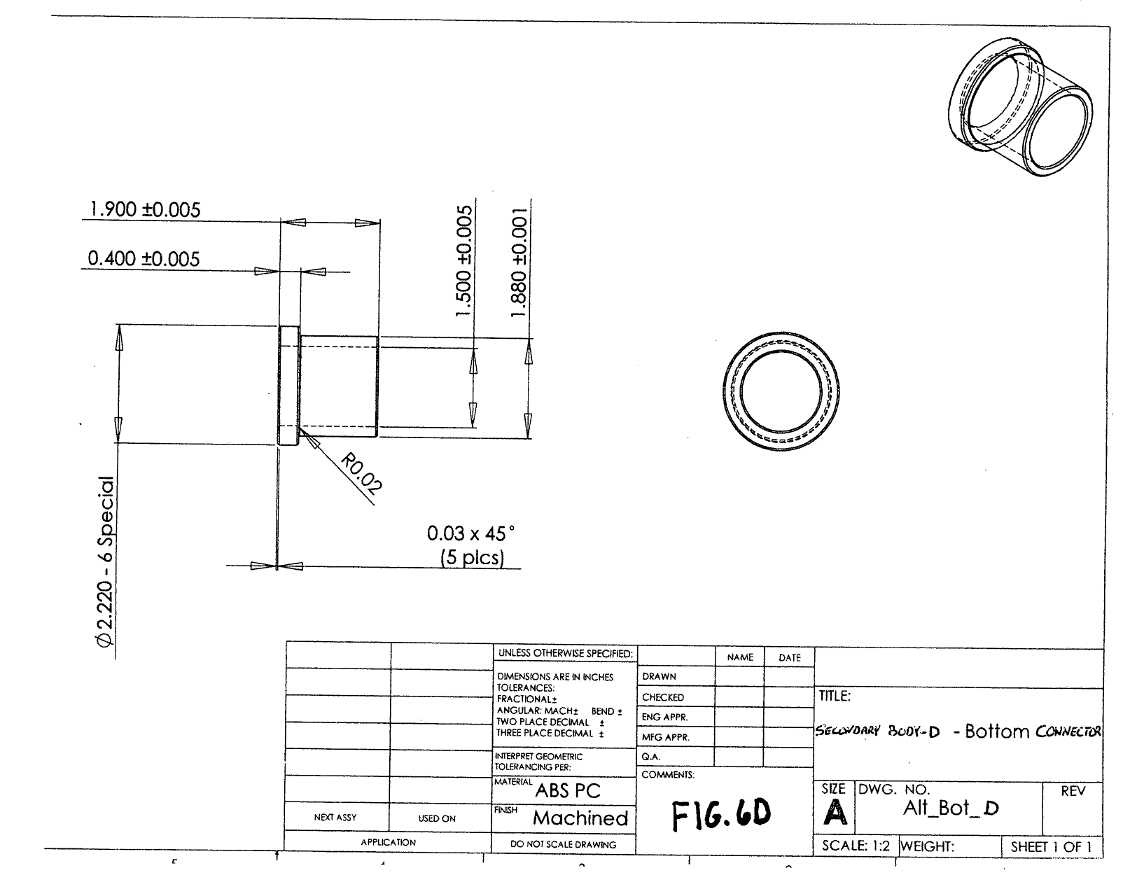

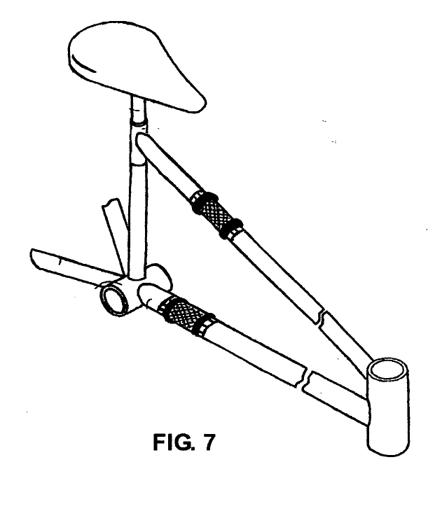

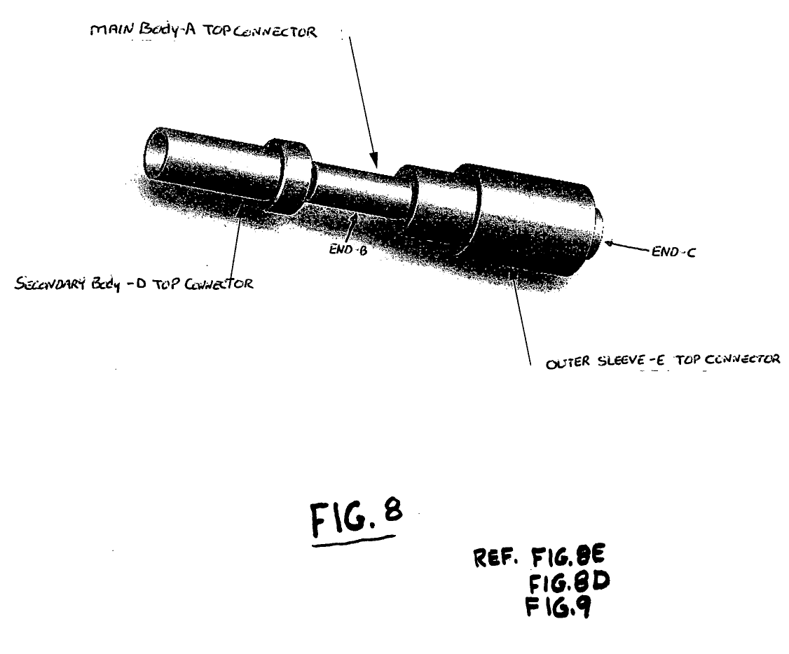

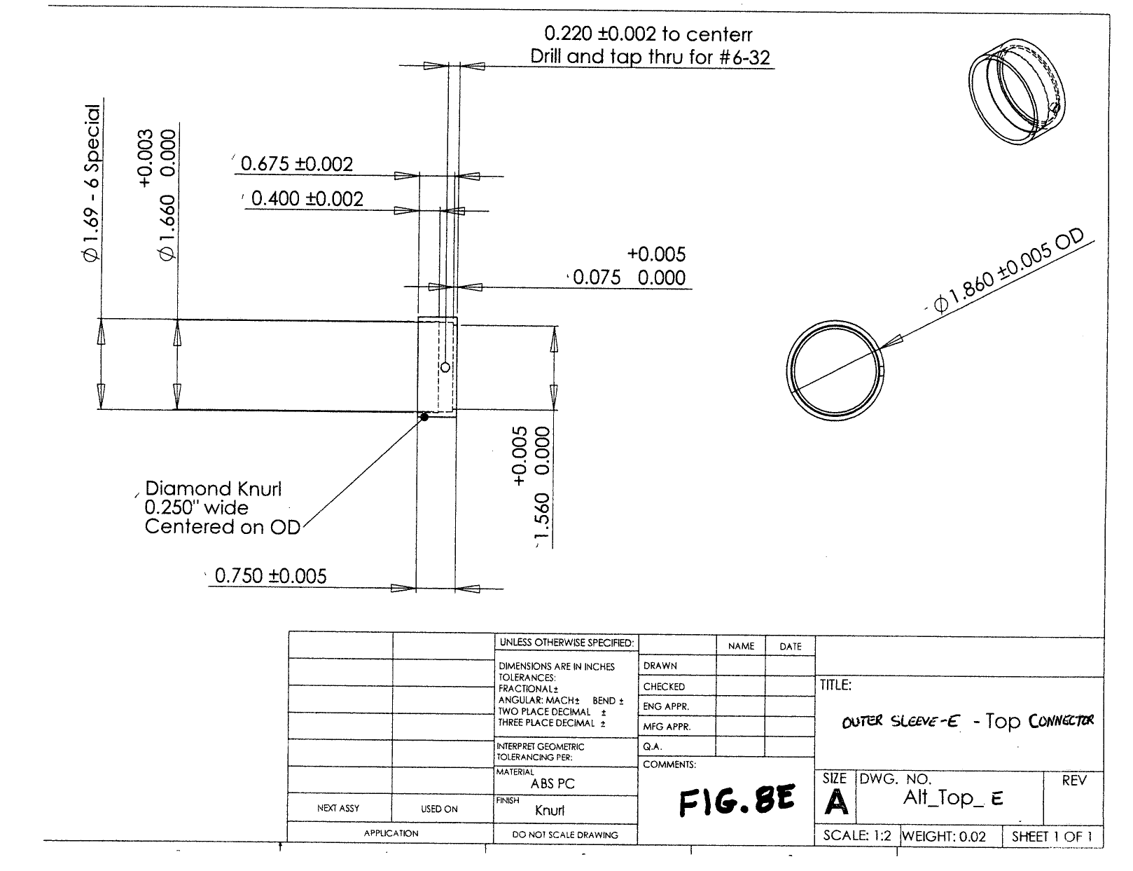

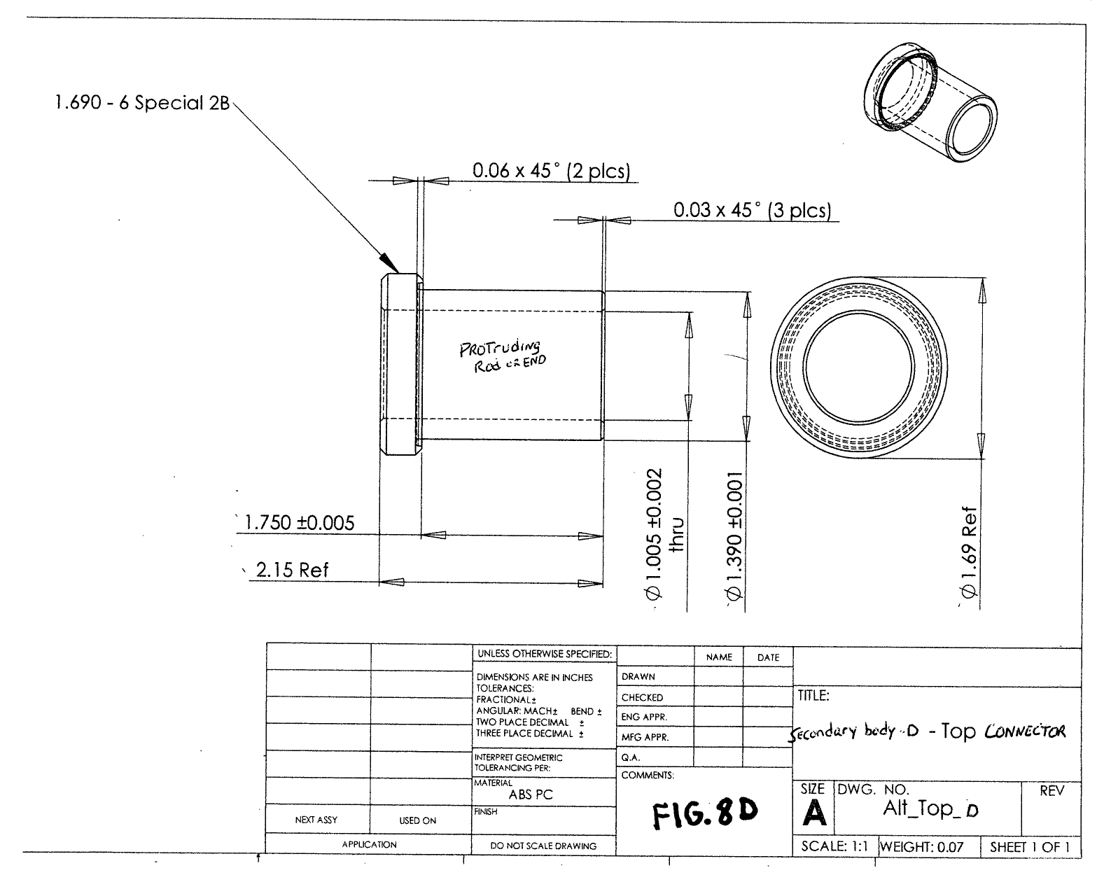

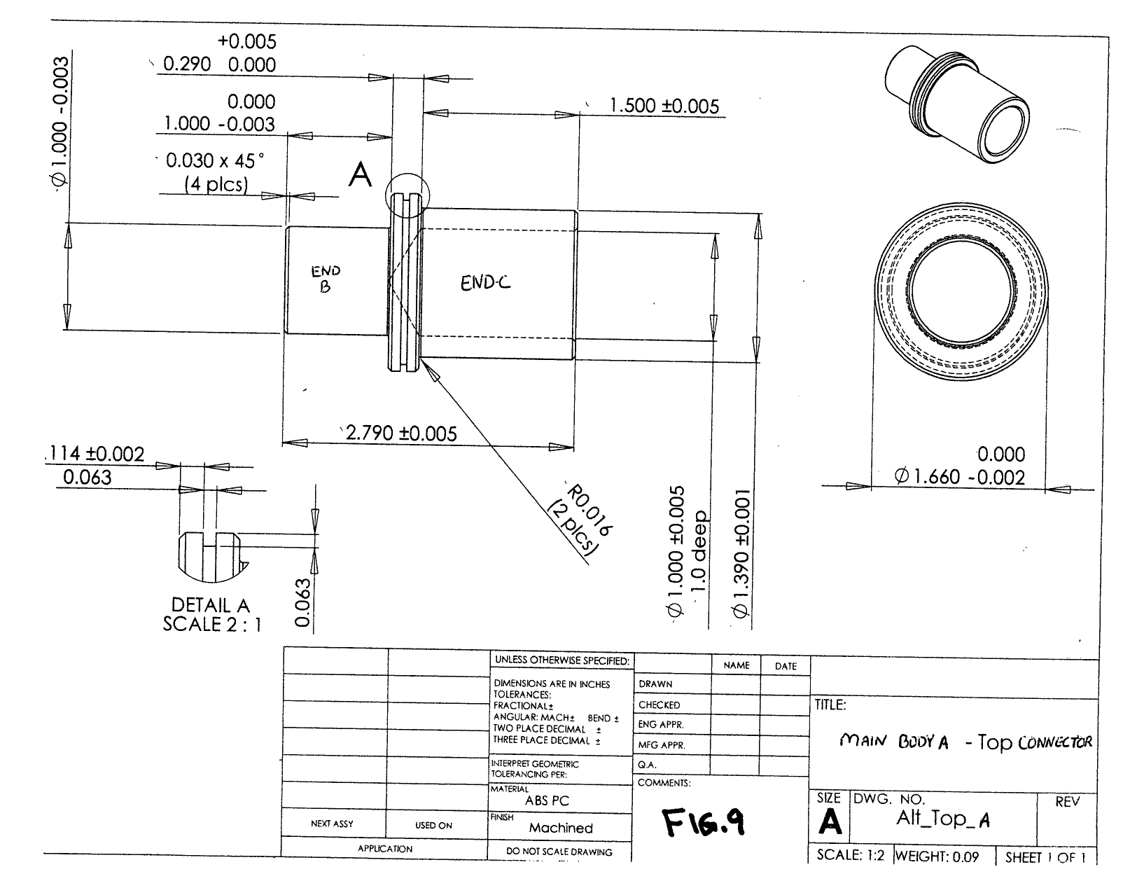

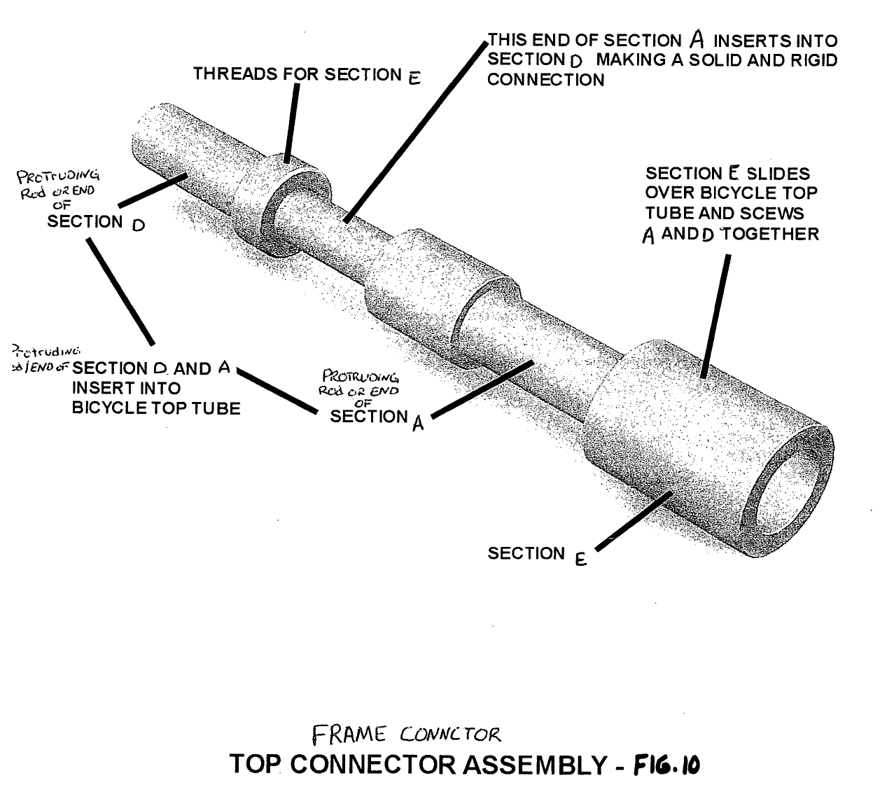

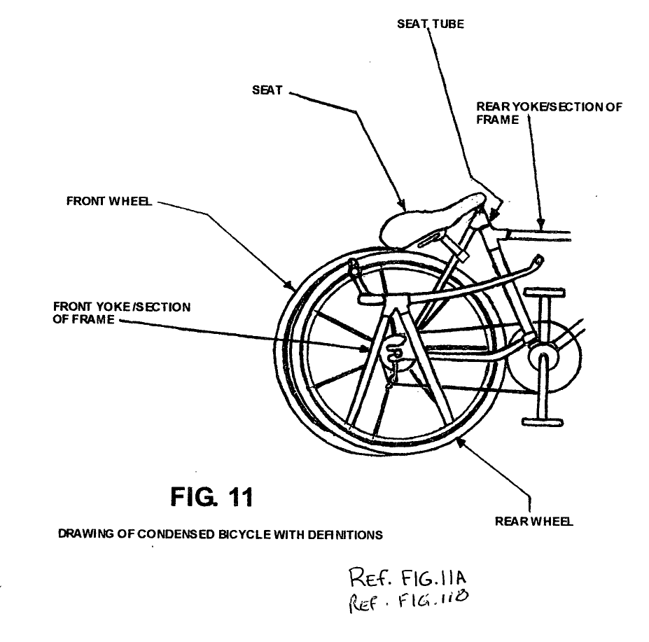

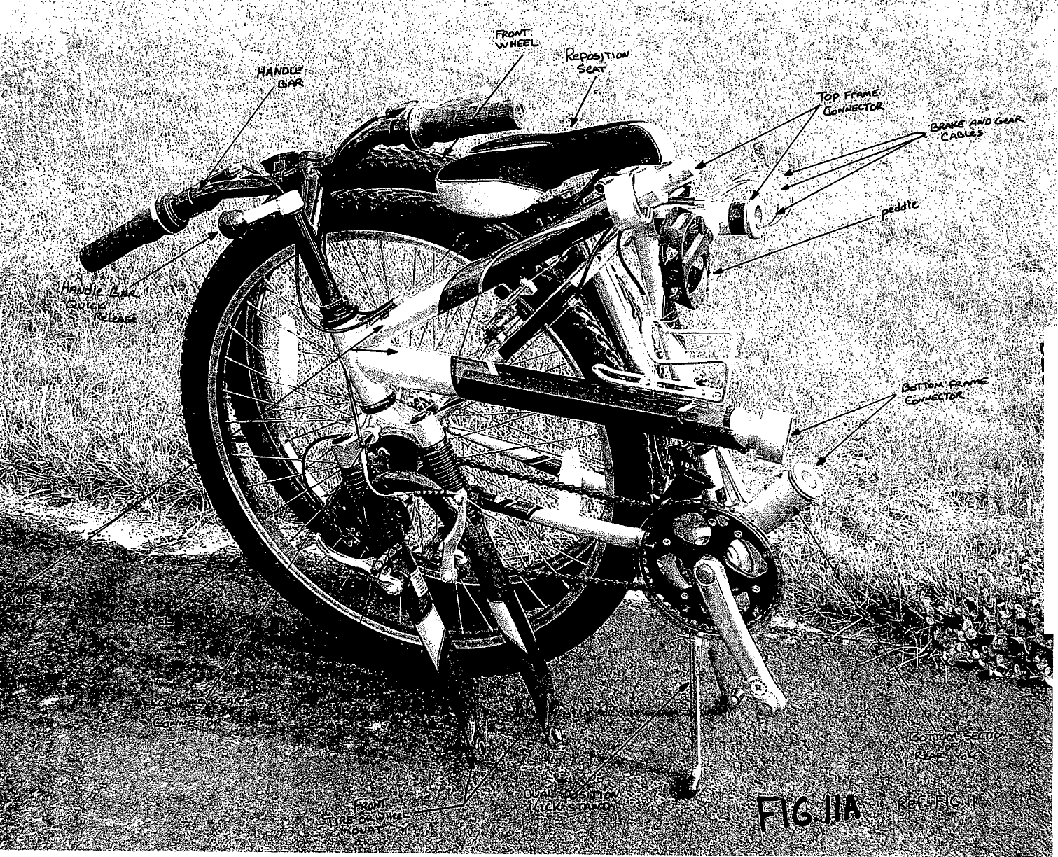

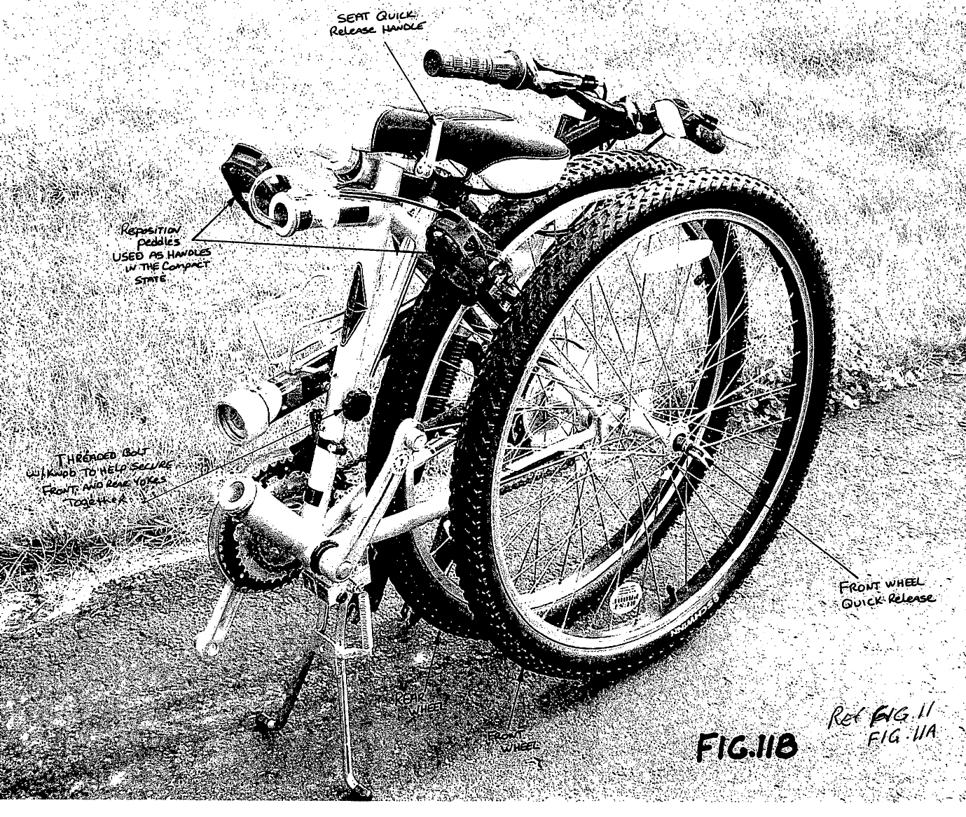

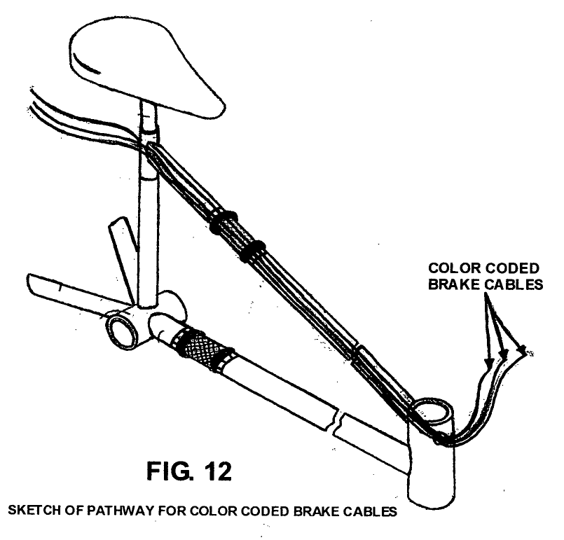

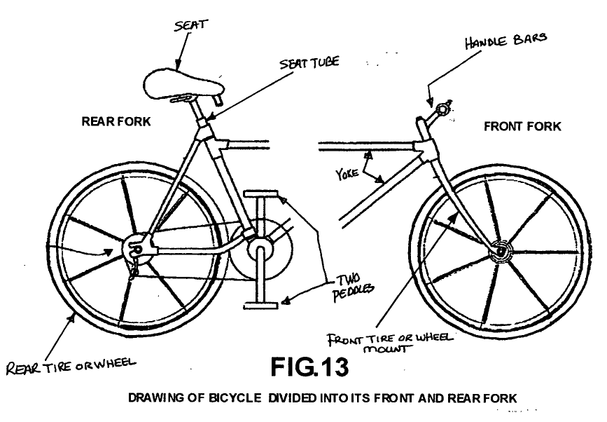

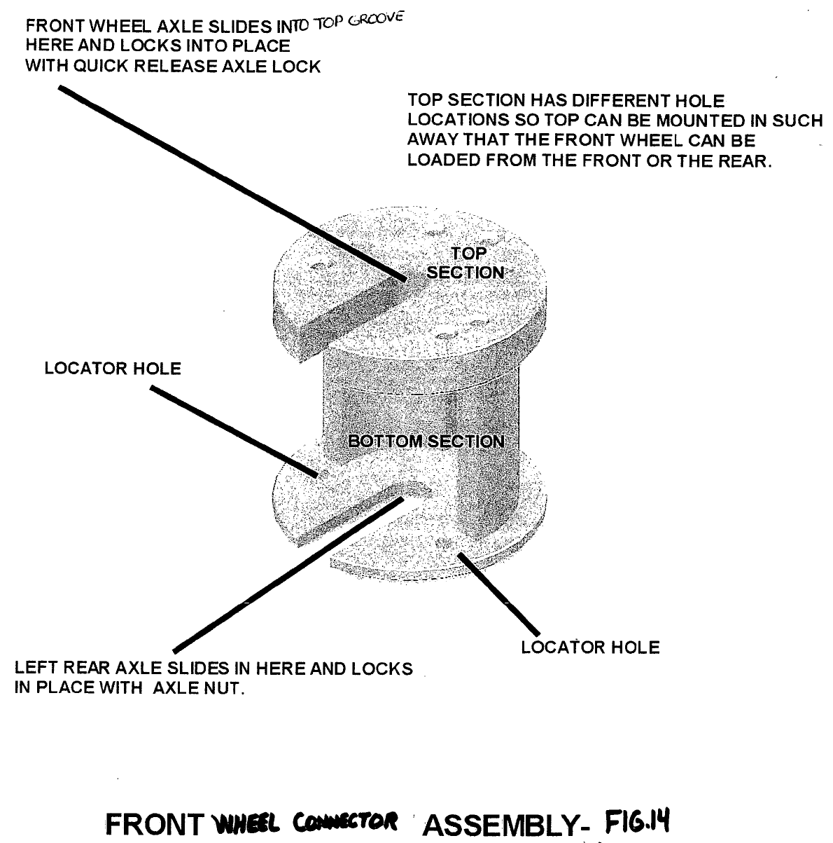

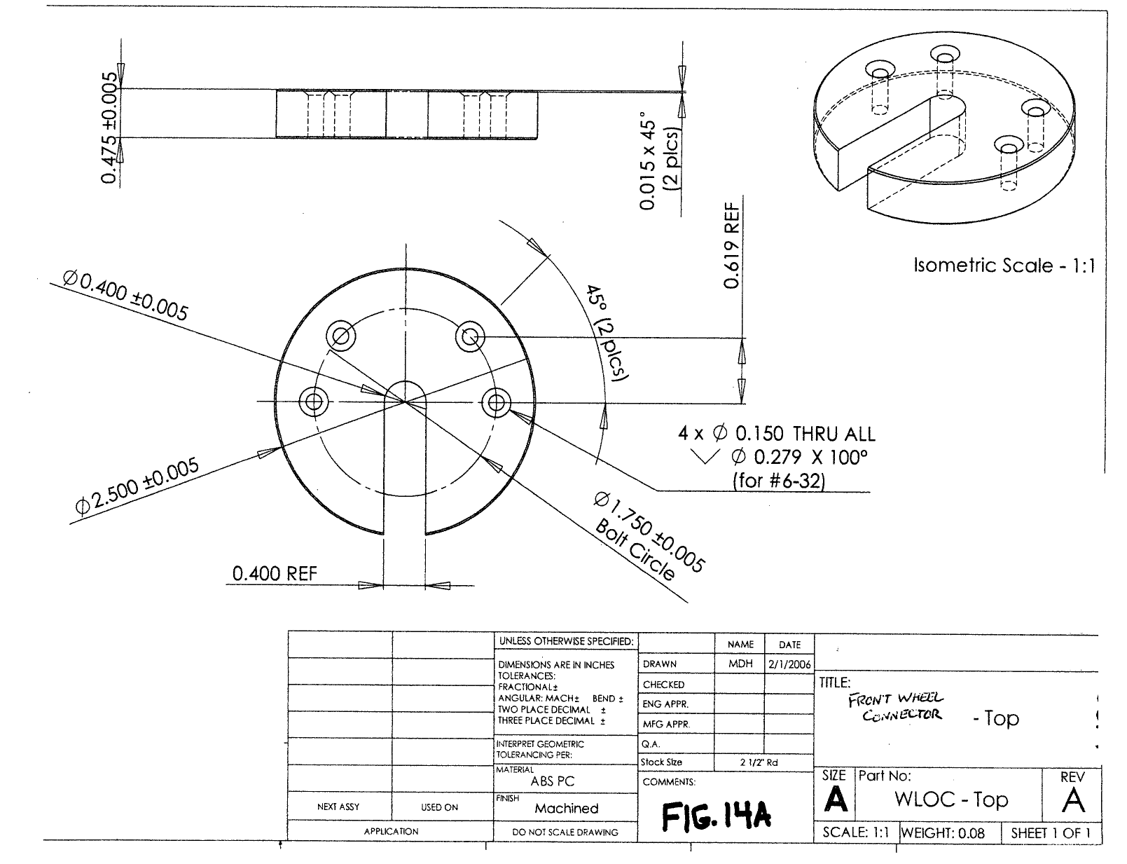

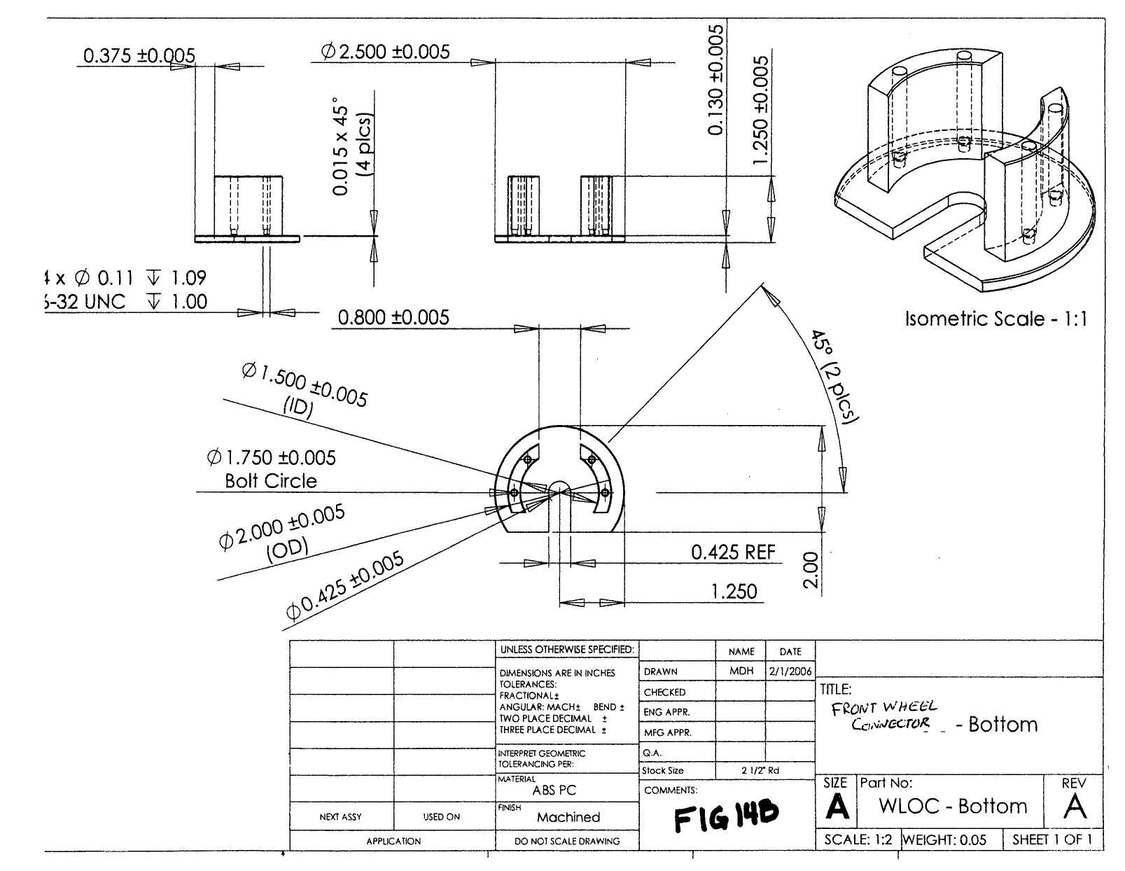

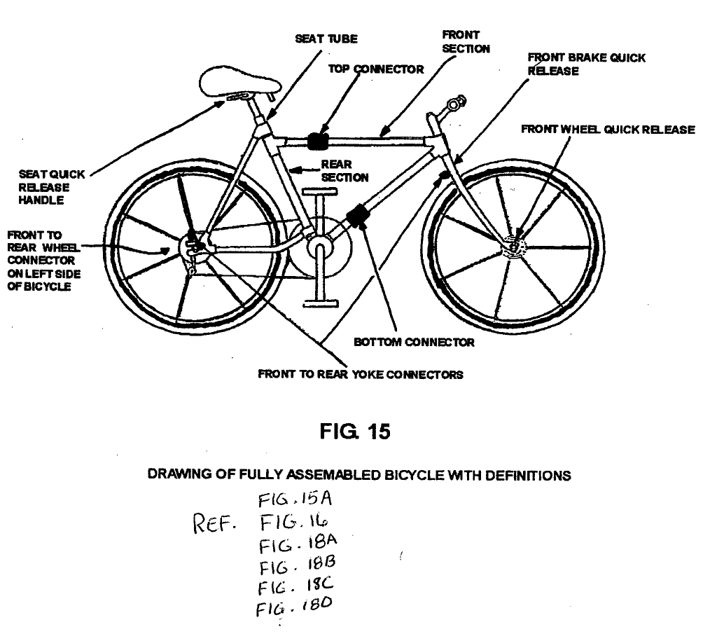

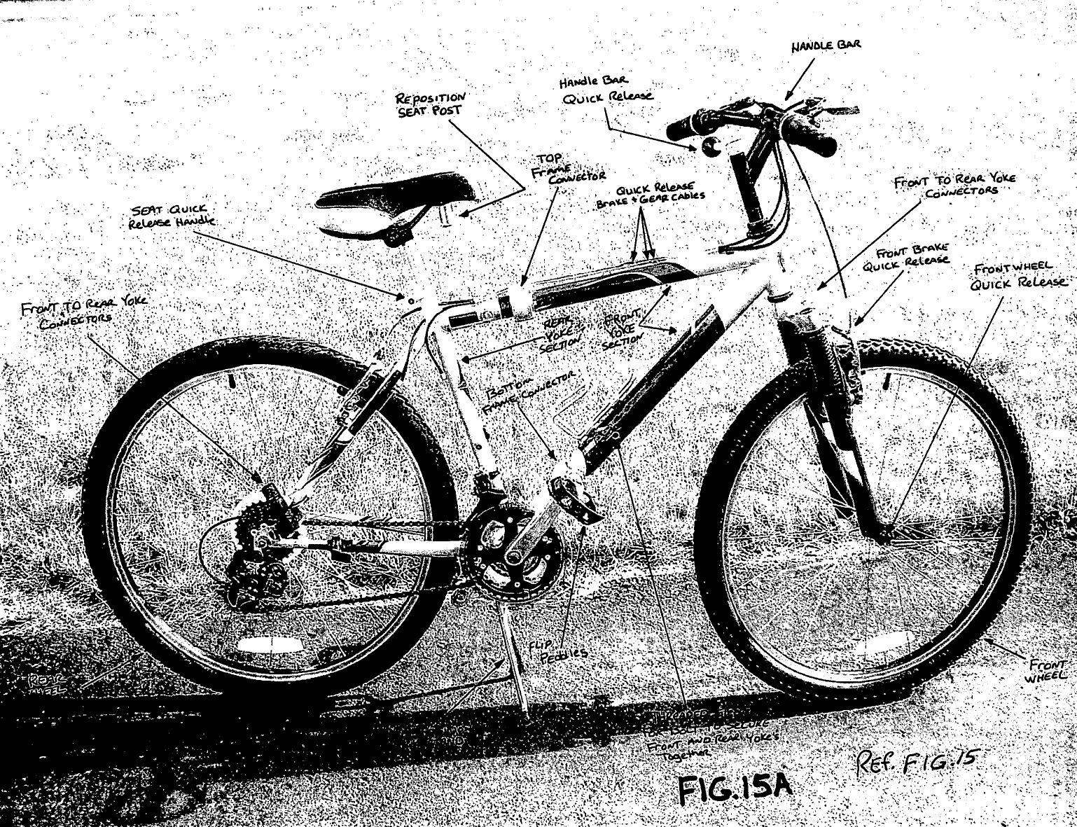

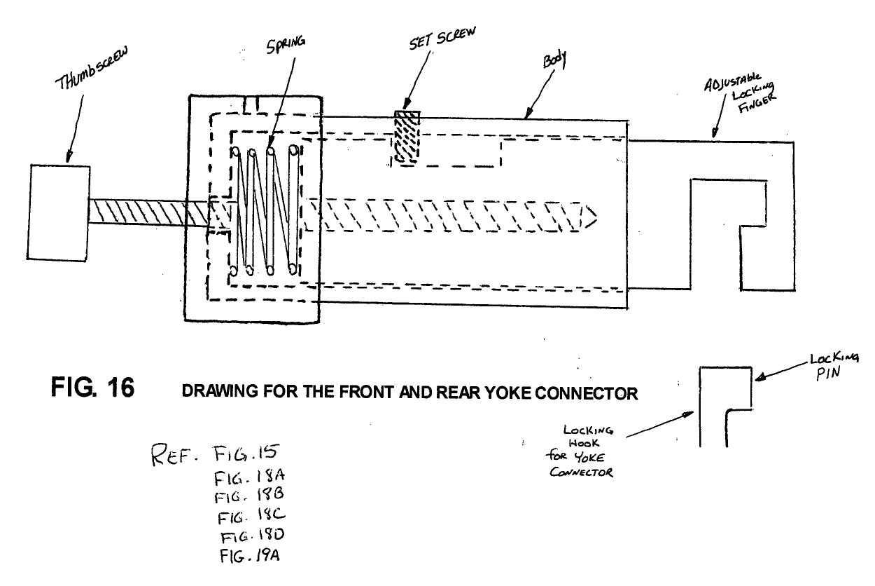

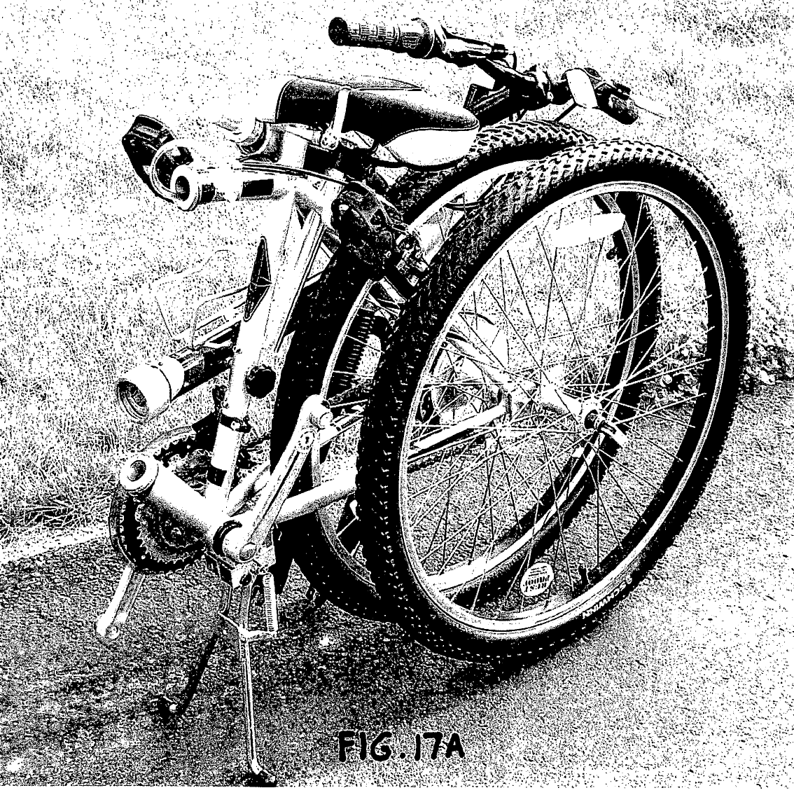

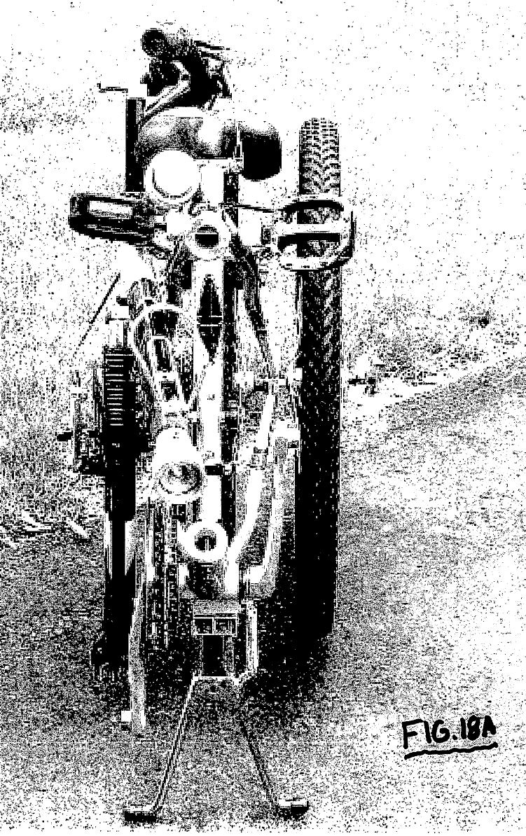

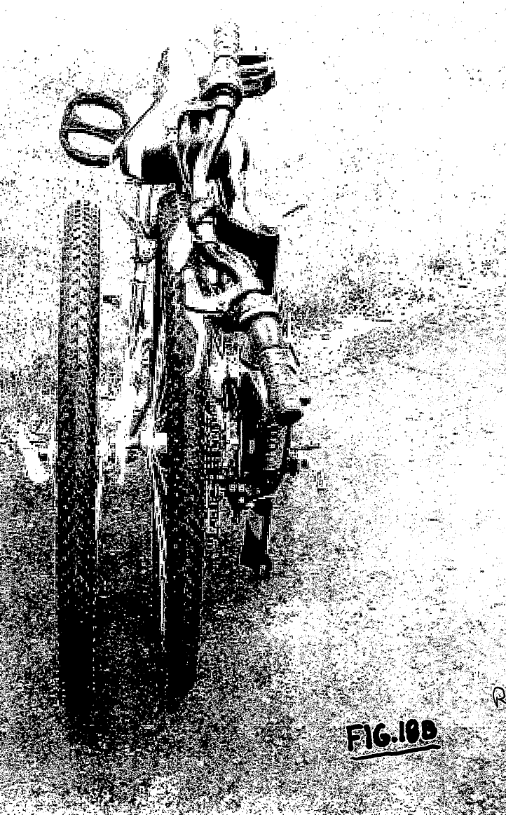

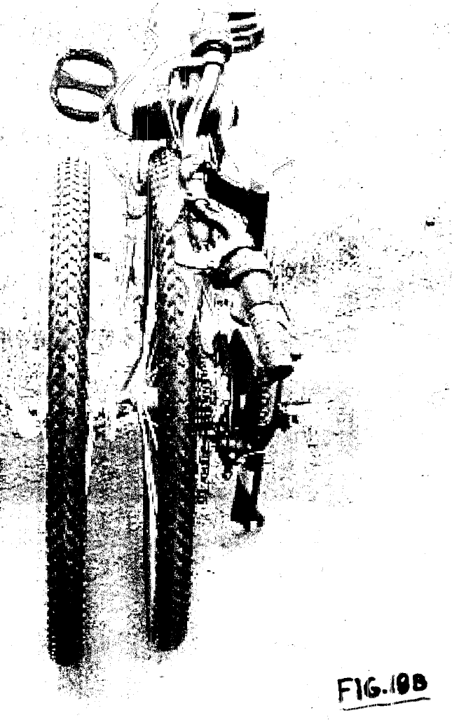

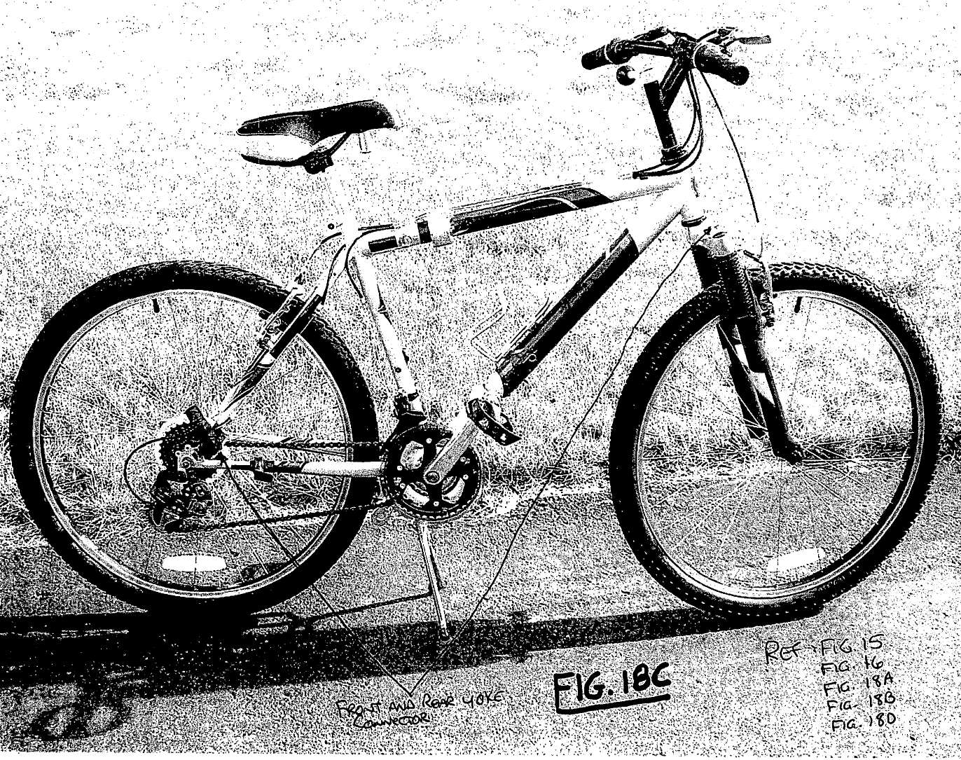

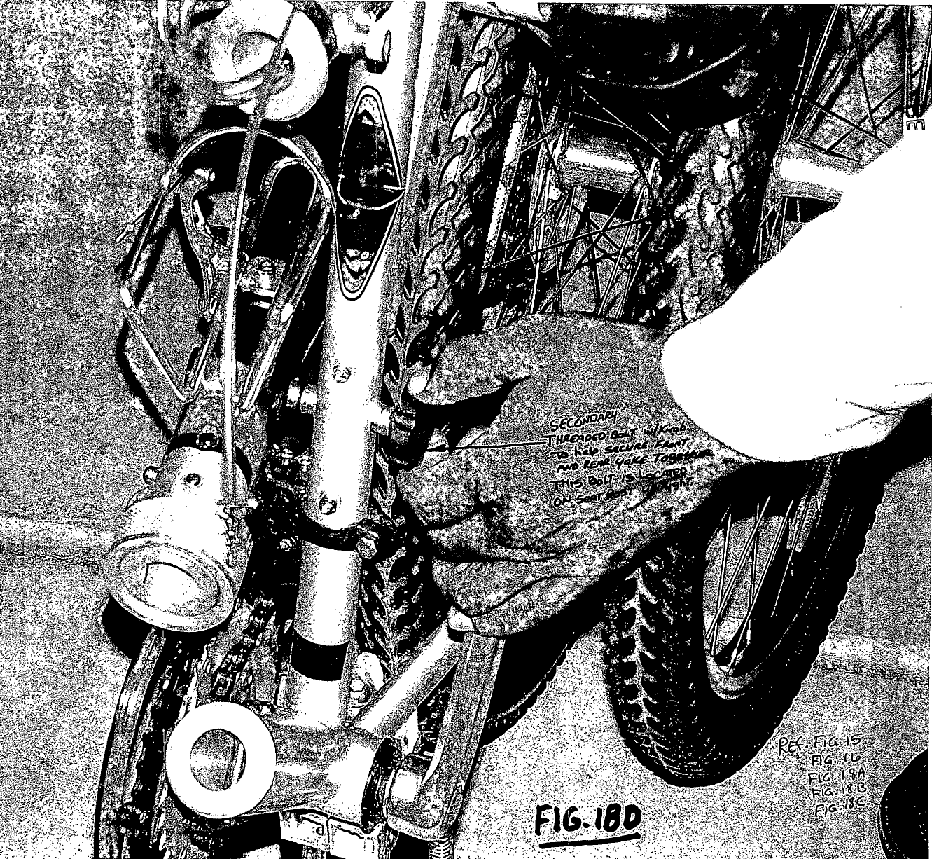

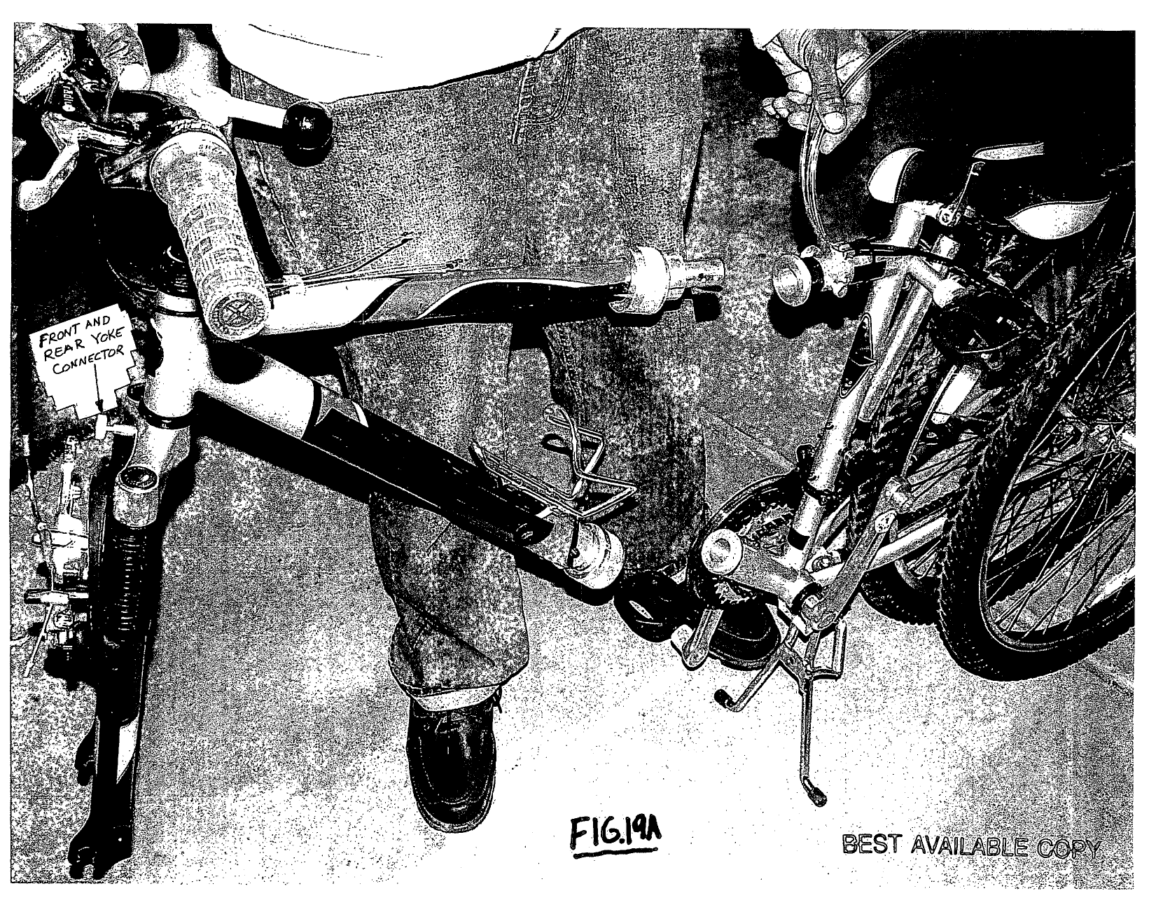

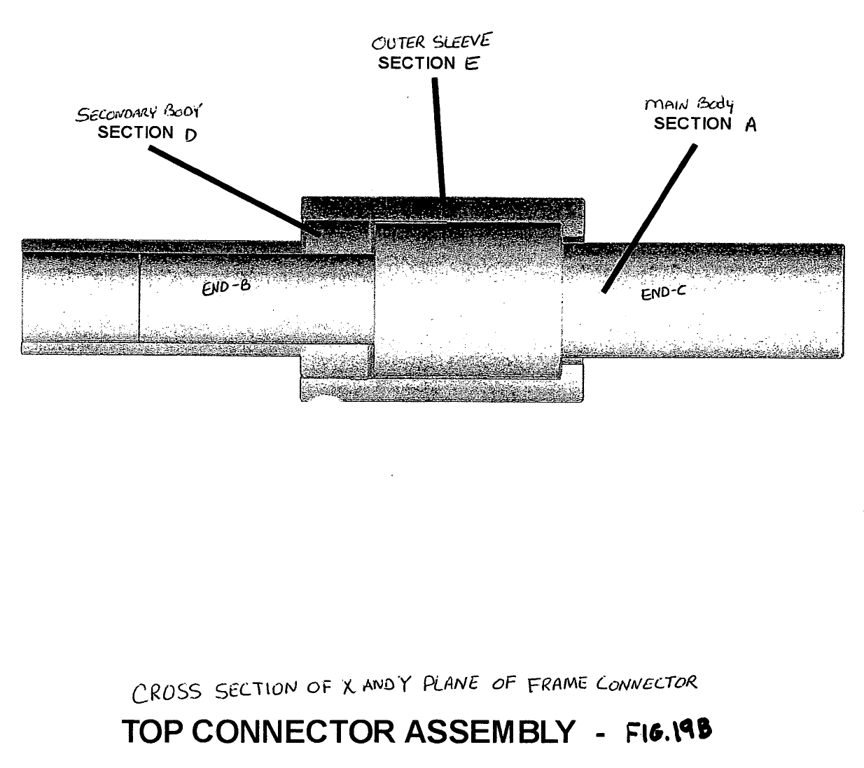

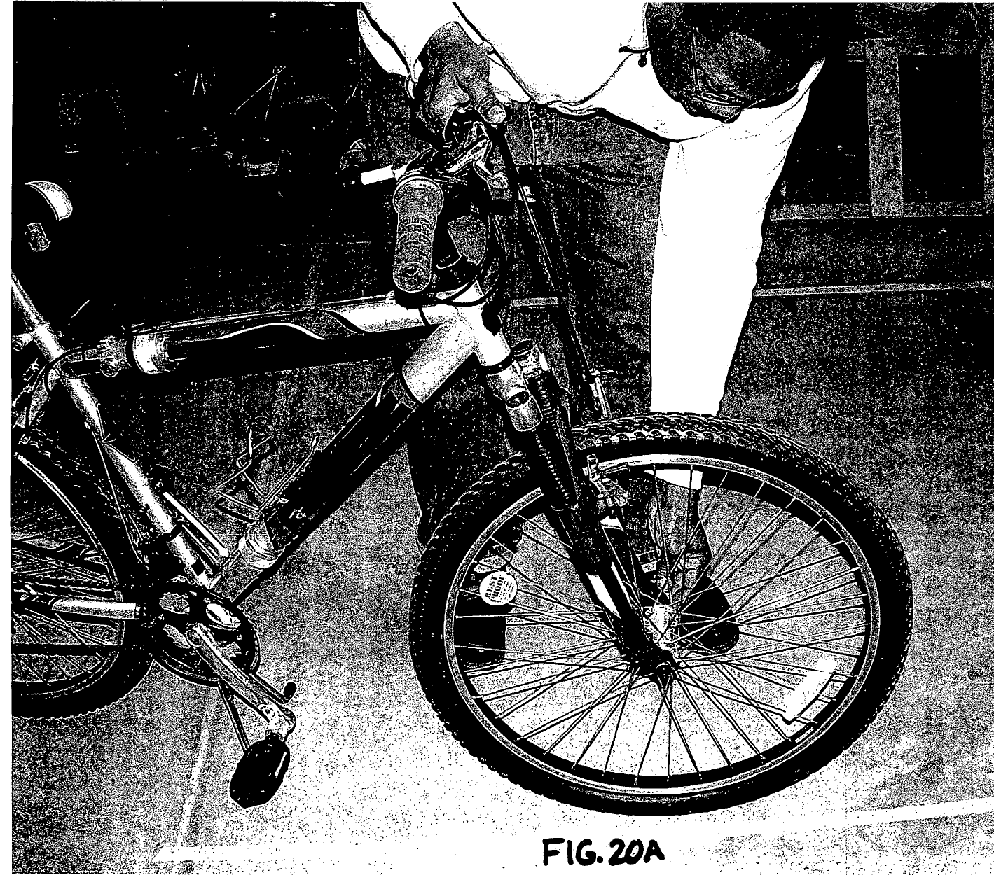

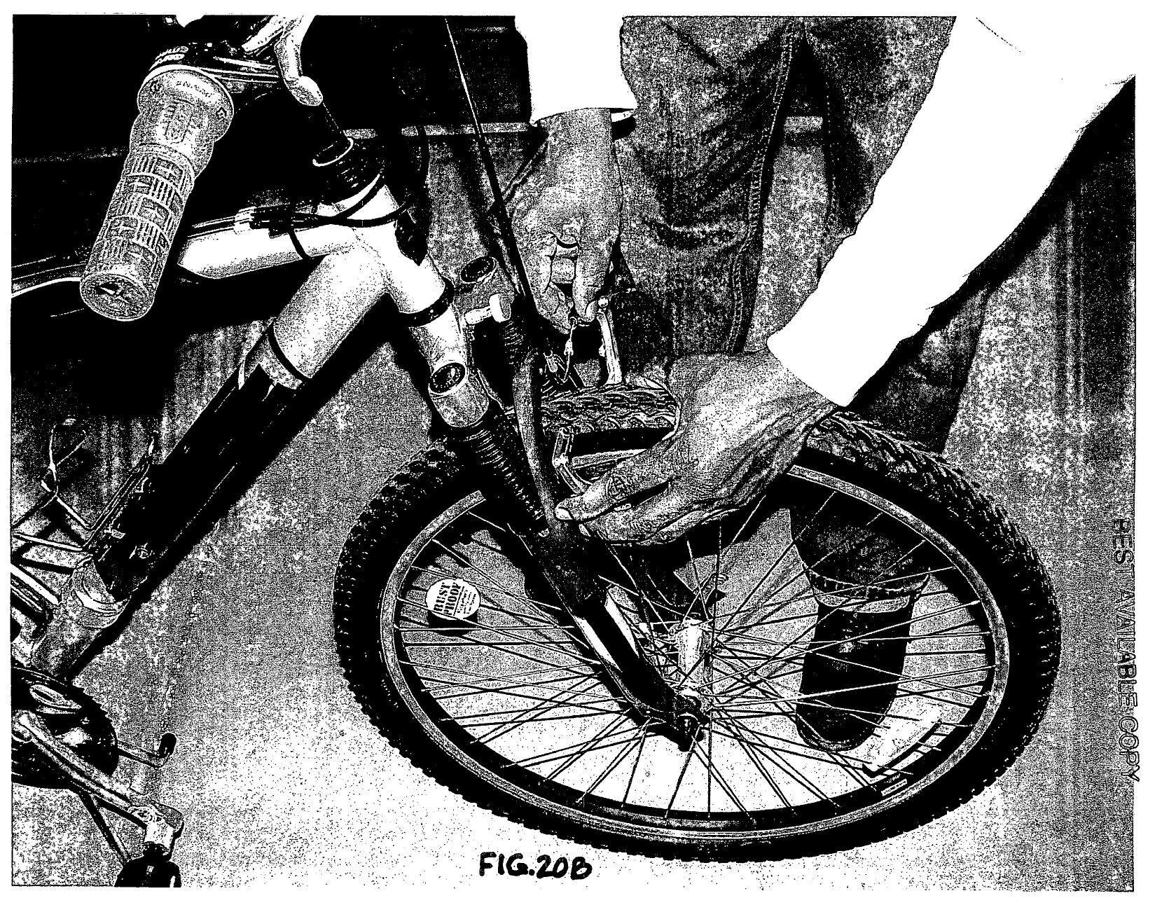

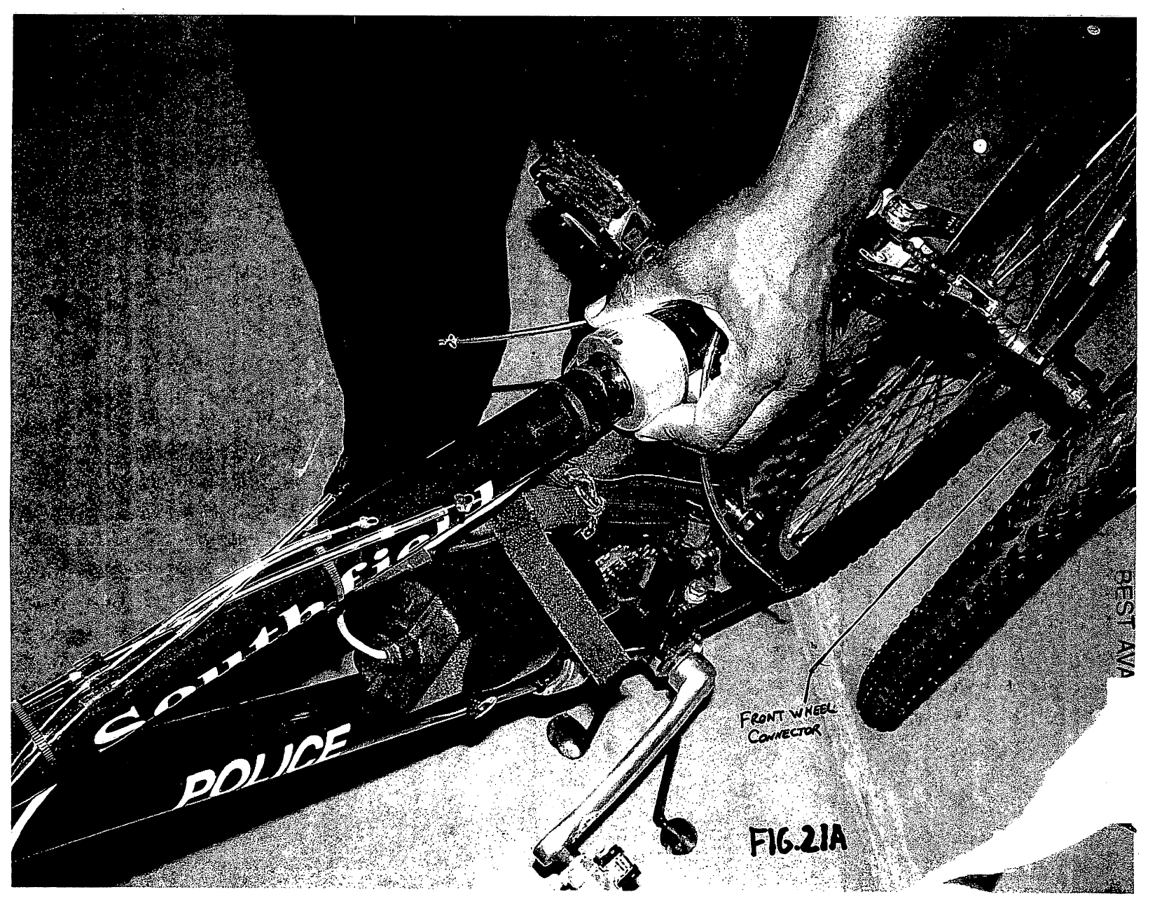

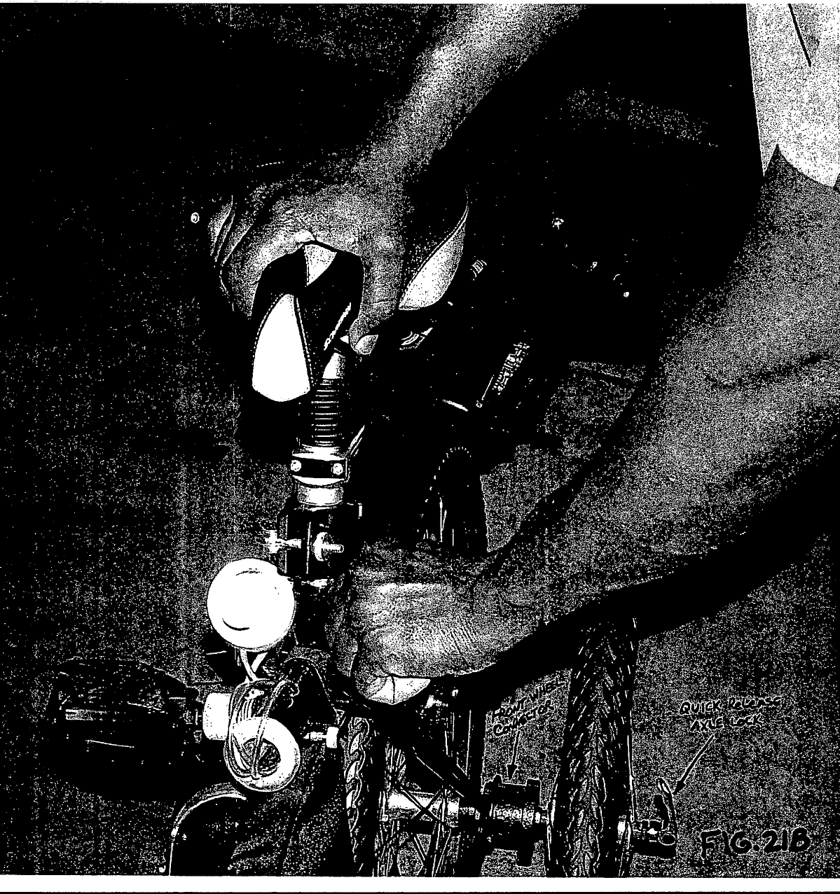

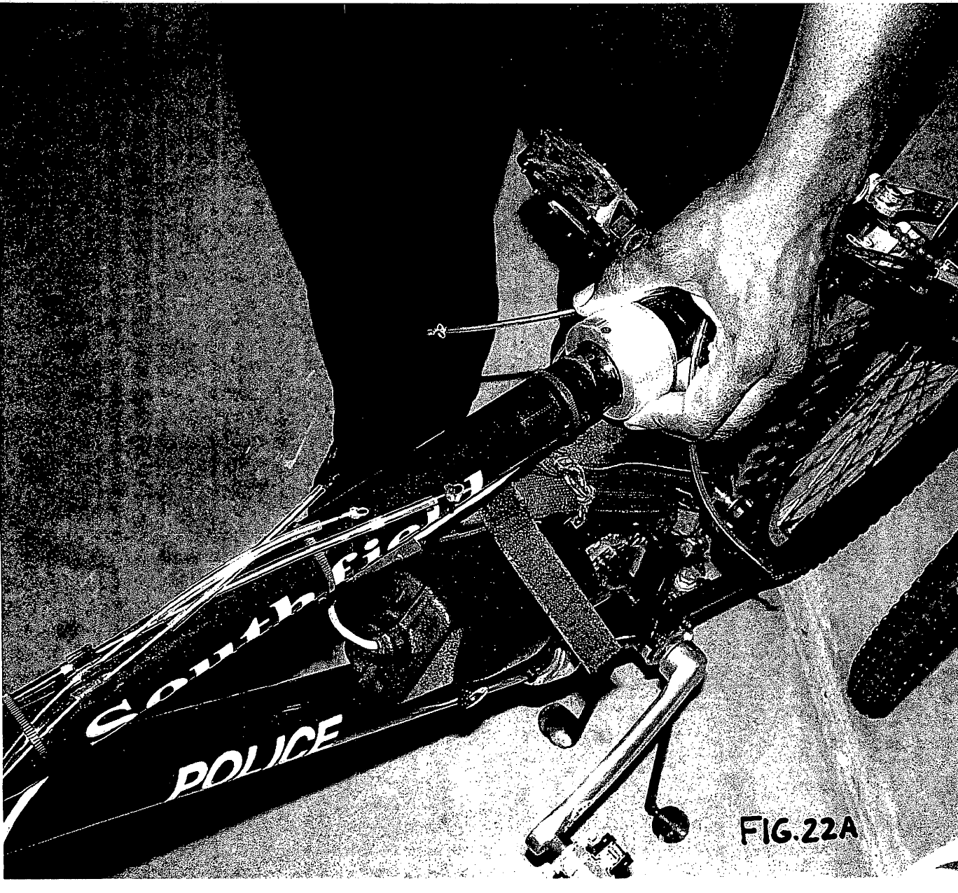

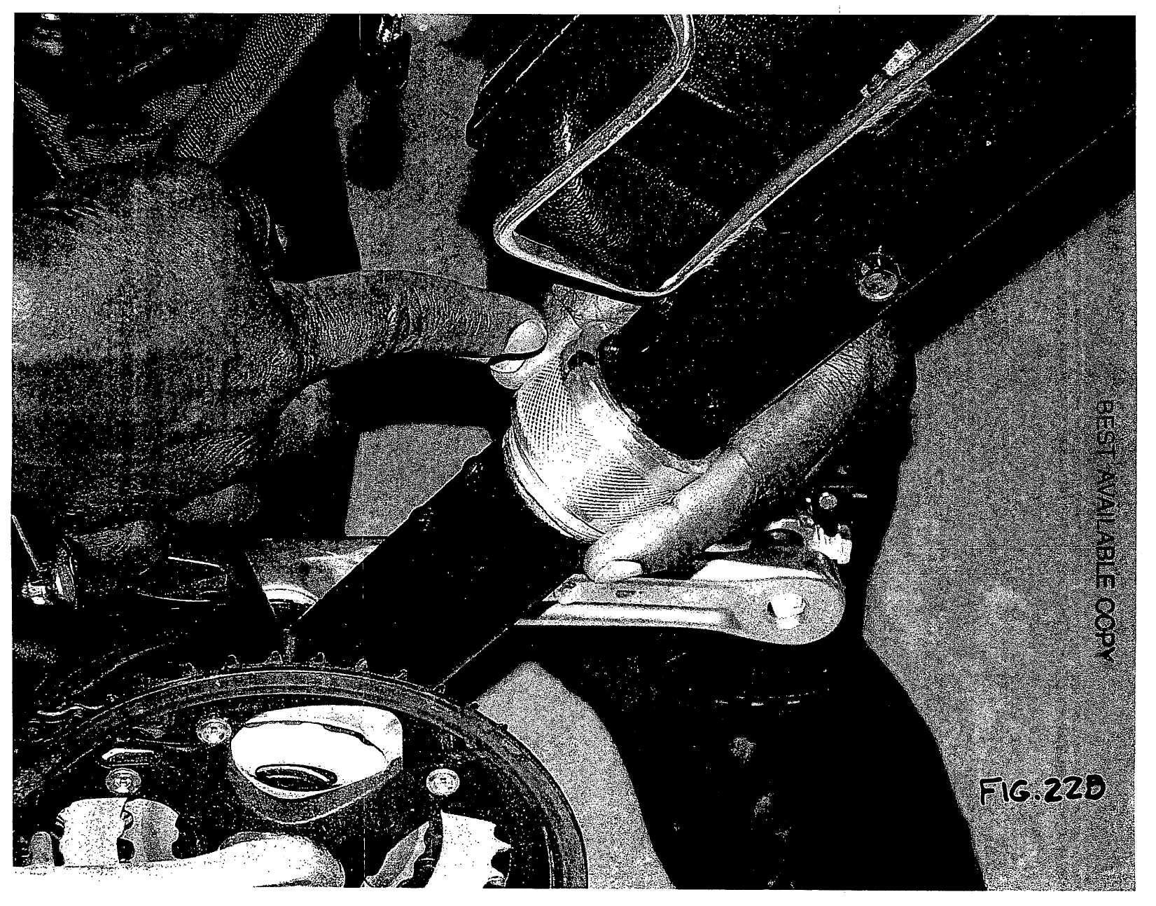

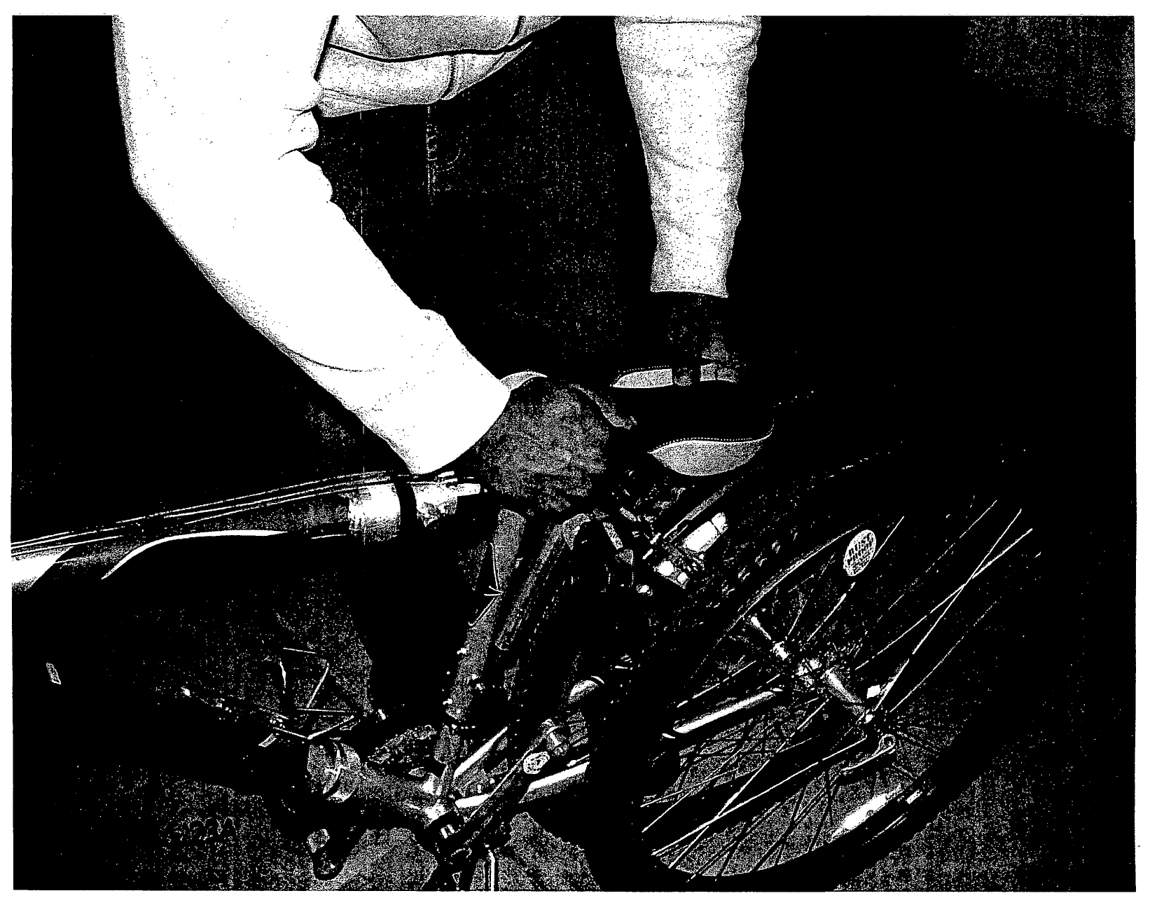

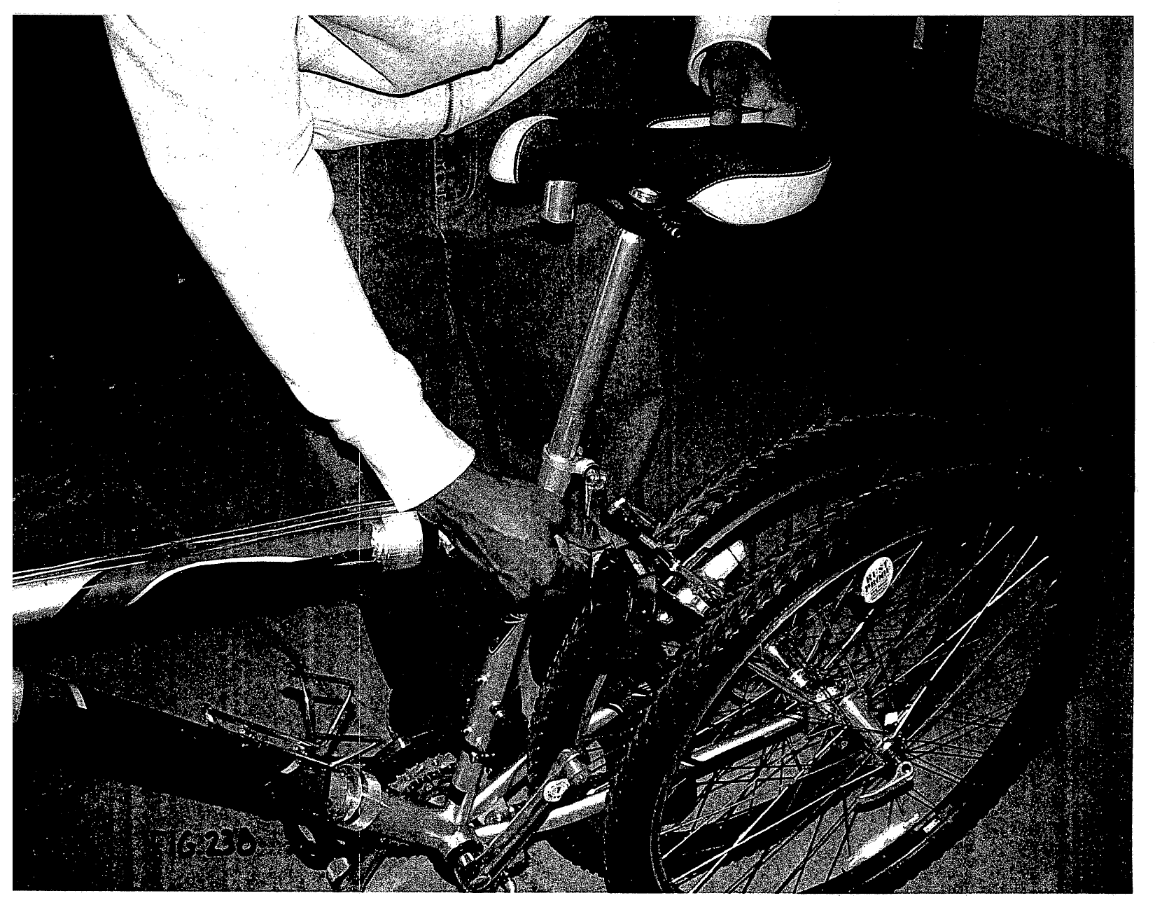

1. The frame connectors allows the bicycle frame to be divided into two sections, one being the front, consisting of the front fork, yoke, two handlebars and a front tire mount, and the second consisting of the rear of the fork, seat, seat tube, two peddles, and a rear tire. SEE FIG. 13. The cables for the bicycle would run through the center of the top bar and through the center of top connector and out the back of seat tube, these cables will have quick disconnects on them. SEE FIG. 2 AND FIG. 12
Now the bicycle can be reassembled in such away that it would fit into a smaller more condensed space. SEE FIGS. 11, 17A AND 18B.

2. This process is completed in less than five minutes while maintaining frame aliment, stability, and rigid ness with these two detachable bicycle frame connectors.

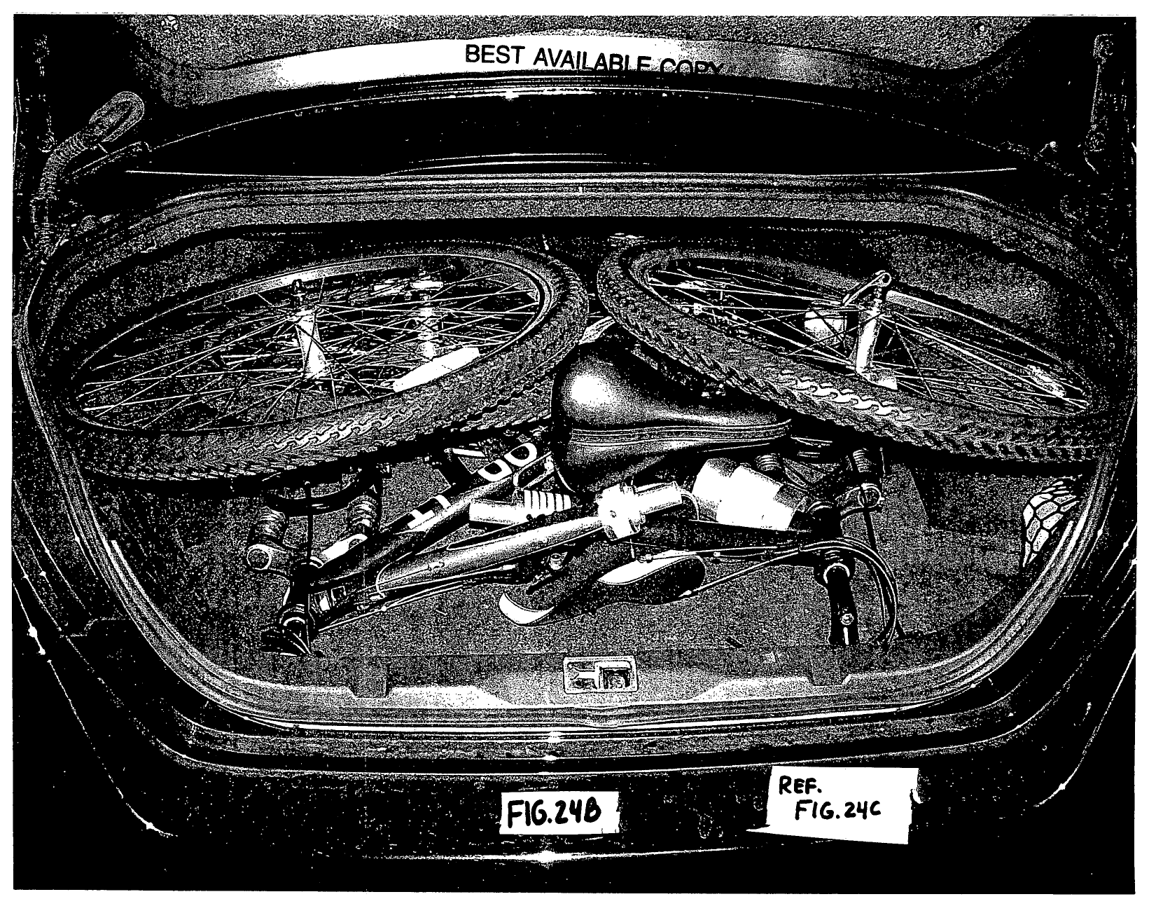

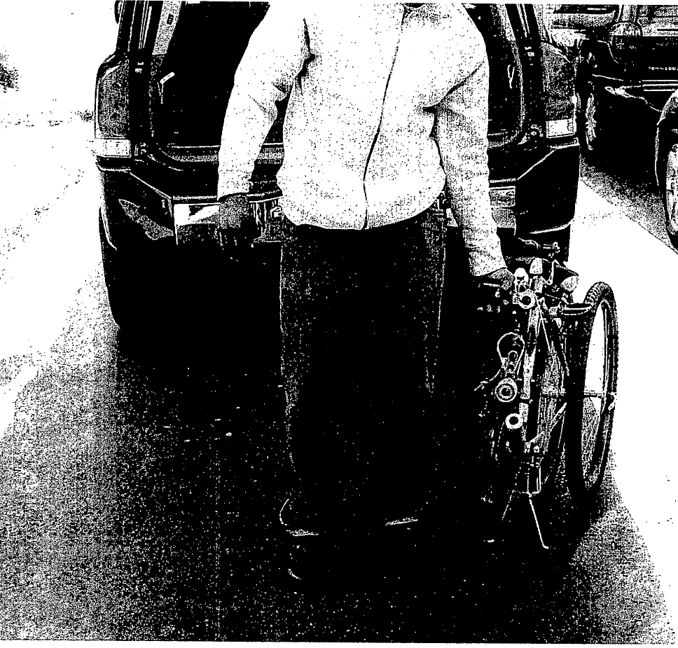

3. Now that the bicycles are broken down into these smaller spaces, they can be easily hand carried to any location, saving space in garages, storing them in a small closet or apartment, or loaded in the trunk of a car. SEE FIG. 24B Now you are able to fit the bicycle inside the vehicle along with there riders without adversely affecting safety during driving, as a bicycle carrier would.
